(19) United States
(12) Patent Application Publication
(10) Pub. No.: US 2014/0341252 A1
(43) Pub. Date: Nov. 20, 2014

(54) DEVICE AND METHOD FOR PROTECTING A LOAD

(71) Applicants: Andreas Krätzschmar, Ammerthal (DE); Siegfried Neumann, Kuemmersbruck (DE); Uwe Weiss, Amberg (DE)

(72) Inventors: Andreas Krätzschmar, Ammerthal (DE); Siegfried Neumann, Kuemmersbruck (DE); Uwe Weiss, Amberg (DE)

(73) Assignee: SIEMENS AKTIENGESELLSCHAFT, Munich (DE)

(21) Appl. No.: 14/344,715

(22) PCT Filed: Sep. 16, 2011
(86) PCT No.: PCT/EP2011/066098

§ 371 Date: Mar. 13, 2014

(51) Int. Cl. H02H 5/04; G01K 13/00

(52) U.S. Cl. CPC H02H 5/04; G01K 13/00
USPC 374/45

(57) ABSTRACT

An embodiment of the invention relates to a device for protecting a load, with a first current path having two lines, and a monitoring arrangement for detecting an imminent overload of the electrical load. In order to enable the detection of an imminent overload on a load, it is proposed that the monitoring arrangement includes a first temperature measuring unit, an evaluation unit and a first transducer, which establishes an electrically conductive connection between the two lines of the first current path, wherein the first temperature measuring unit is electrically isolated from the first transducer and can record a temperature of the first transducer, wherein the evaluation unit can determine, using recorded temperatures of the first transducer, a temporary heating behaviour of the first transducer, and can determine, by evaluating the determined temporary heating behaviour of the first transducer, an imminent overload on the load.

### PRIORITY STATEMENT

This application is the national phase under 35 U.S.C. §371 of PCT International Application No. PCT/EP2011/066098 which has an International filing date of Sep. 16, 2011, which designated the United States of America, the entire contents of which are hereby incorporated herein by reference.

### FIELD

At least one embodiment of the invention generally relates to a device and/or a method for protecting a load against overload, in particular thermal overload.

### BACKGROUND

An electric motor (e.g. an asynchronous motor), a cable and/or a conductor line, in particular, can be regarded herein as loads. A thermal overload on the load arises due to excessive current flow caused, for example, by mechanical overloading of an electric motor or the failure of one or two conducting routes (phases) of the electric motor. This leads to undesirable heat generation at the load, which ultimately can lead to damaging of the load.

In order to detect an imminent thermal overload on an electrical load, devices are typically integrated into the conducting route via which the load is supplied with electrical energy, so that an imminent thermal overload can be detected with said devices. Single-phase or multi-phase monitoring can take place, that is, a single conducting route (one phase) or a plurality of conducting routes (multiple phases) of the load can be monitored.

The respective devices have a current path for each conducting route to be monitored, by which the energy supply taking place via the conducting route is guided. The electrical energy of the load is therefore fed via the current path through the device. The current flow in the current path is monitored by way of a monitoring arrangement of the device so that an imminent overload on the load can be detected. Devices of this type are, for example, overload relays or circuit breakers. Apart from protection against thermal overload by way of an A-release, a circuit breaker also has a short-circuit protection for a downstream load by way of an N-release.

In the present application, overload protection can be provided for a load (e.g. motors, lines, transformers and generators).

A variety of requirements are placed on a device for determining a thermal overload on a load:
The device should, as far as possible, be able to monitor both AC and DC currents so that both AC and DC loads can be monitored for overload.
The device should have the largest possible setting range. The setting range is the range within which monitoring of the operating current of the electrical load can take place. Said setting range is limited by the operating current upper limit Iₒ and the operating current lower limit Iᵤ (Iₒ to Iᵤ). Using the setting device (e.g. a setting screw) at the device, the thermal overload trigger can be set to the relevant nominal current of the load, so that targeted monitoring of the downstream load to be monitored can take place.
The device should generate the smallest possible power loss.
The device should have the simplest possible electrical isolation between the current path to be monitored and the monitoring arrangement which detects the overload.
The device should have a thermal memory. I.e. if an imminent thermal overload on a load is detected, the current feed to the load should be interrupted for long enough until cooling of the load is assured. Thus, no immediate connection of a load should be enabled following the determination of a thermal overload.

If a thermal overload on a load is imminent, an increased current rise takes place in the individual conducting routes (phases) of the load. A device connected upstream of the load for monitoring a thermal overload on the load can therefore detect and evaluate this increased current rise by monitoring the current path thereof. Different measuring principles can be used for this. Detection of an imminent overload can therefore be carried out with different monitoring arrangements of the device.

Monitoring arrangements for detecting an overload on a load typically include a bimetallic release, a current transformer or a shunt on the corresponding current path for each phase of the load to be monitored.

In the case of monitoring by way of a bimetallic release, the current path to be monitored is coupled to a bimetallic release in such a way that, due to the current rise, heating of the bimetallic release, and ultimately a spatial deflection of a part of the bimetallic release, takes place. This deflection is detected and further evaluated. Using a bimetallic release, both direct currents and alternating currents can be detected. The typical setting range of the bimetallic release is from 1 to 1.6. A disadvantage of the bimetallic release is that it generates a high power loss. The thermal memory and the electrical isolation between the individual conducting routes (phases), however, can be achieved with little effort in the case of bimetallic releases.

In the case of monitoring by way of a current transformer, the respective current transformer detects the current flow in the current path thereof, so that an evaluation unit can carry out a further analysis of the current flow and ultimately detect an imminent overload. A disadvantage of this measuring method is that DC currents cannot be detected. The setting range is from 1 to 10 and the power loss is low. However, a thermal memory cannot be simulated by the current transformer itself.

In the case of monitoring by way of a shunt, the shunt is integrated into the current path, so that thereby, voltage tapping used to characterize the current flow can be carried out. Downstream analysis of the voltage across the shunt enables an imminent thermal overload to be detected. Using a shunt measurement method, detection of AC/DC currents is possible. The setting range is typically from 1 to 4. A disadvantage of the measuring method using a shunt is that a thermal memory cannot be simulated with voltage tapping at the shunt and the electrical isolation of the individual phases is possible only with the greatest difficulty.

A temperature monitoring device by which overheating of semiconductor switching elements is monitored is known from US 2005/0204761 A1. By way of the semiconductor switching elements, the DC current provided by a battery is converted to AC current in a motor vehicle, so that an electric motor of the vehicle can be operated with AC current. The semiconductor switching elements are cooled with a liquid cooling system. The temperature of the semiconductor switching elements is monitored by way of the determined temperature of a temperature sensor. The temperature sensor records either the temperature of the liquid coolant of the liquid cooling system or the temperature in the region of the semiconductor switching elements.

### SUMMARY

At least one embodiment of the present invention is directed to a device and/or a method with which the detection of an imminent overload on a load can take place. In particular, it should be possible with the device of at least one embodiment to monitor both direct currents and alternating currents. Furthermore, a simple electrical isolation of the monitoring arrangement from the current path to be monitored should preferably be enabled.

A device is disclosed in at least one embodiment for protecting a load, with a first current path having two lines, and a monitoring arrangement for detecting an imminent overload on the load. The monitoring arrangement includes a first temperature measuring unit, an evaluation unit and a first transducer which establishes an electrically conductive connection between the two lines of the first current path, wherein the first temperature measuring unit is electrically isolated from the first transducer and can record a temperature of the first transducer, wherein the evaluation unit can determine, using recorded temperatures of the first transducer, a heating behavior of the first transducer and can detect, by evaluating the determined heating behavior of the first transducer, an imminent overload on the load.

A method is disclosed in at least one embodiment for protecting a load, wherein a device comprises a first current path having two lines and a monitoring arrangement for detecting an imminent overload on the load, the monitoring arrangement comprising a first temperature measuring unit, an evaluation unit and a first transducer which establishes an electrically conductive connection between the two lines of the first current path, wherein the first temperature measuring unit is electrically isolated from the first transducer and records a temperature of the first transducer at least twice and the evaluation unit determines, using the recorded temperatures of the first transducer, a heating behavior of the first transducer and, by evaluating the determined heating behavior of the first transducer, can detect an imminent overload on the load.

Advantageous developments of the invention are disclosed in dependent claims.

### BRIEF DESCRIPTION OF THE DRAWINGS

The invention and embodiments of the invention will now be described in greater detail making reference to the example embodiments illustrated in the drawings, in which:

FIG. 1 is a schematic view of a first current path which comprises a monitoring arrangement, and

FIG. 2 is a schematic representation of a device for protecting an electrical load.

### DETAILED DESCRIPTION OF THE EXAMPLE EMBODIMENTS

The current path is, in particular, part of a supply conductor of an energy supply for the load. The supply conductor is also referred to as a main circuit or a phase. During active operation of the load (e.g. an electric motor), a time-dependent motor current flows through the current path and therefore through the first transducer, leading in the first transducer to a defined heating of the first transducer (current-related heating) depending on the size of the current and the conducting interval. If an overload on the load is imminent, the thermal behavior of the first transducer in relation to the thermal behavior during standard operation of the load is characteristic. In particular, if an overload is imminent, a raised temperature is found at the first transducer in relation to standard operation.

This leads to a characteristic heating behavior of the first transducer which can be determined and evaluated by the evaluation unit. In particular, the evaluation unit performs an analysis of the determined temperature of the first transducer over time, so that an imminent overload on the load can be detected. Preferably, the heating behavior of the first transducer over a defined time interval is evaluated.

The heating behavior of the transducer is understood, in particular, to be the change over time of the temperature of a temperature measurement site at the first transducer or the change over time of a temperature difference between two or a plurality of temperature measurement sites (e.g. difference between the temperature of the first transducer and a reference temperature). Through this change over time of the temperature or the temperature difference of two temperature measurement sites, that is, the heating behavior, a conclusion can be drawn regarding the current change over time. Based on this current change over time, also, an overload state of the load can be concluded.

Preferably, the sampling over time of the temperature measurement site(s), determination of possible temperature differences, determination of the temperature change over time and the conclusion about the current change over time or the overload status take place in the evaluation unit.

The temperature of the first transducer can be recorded by the first temperature measuring unit and made available to the evaluation unit. The evaluation unit can preferably determine the heating behavior of the first transducer through an analysis of the recorded temperature over time and/or by way of an additional reference temperature recorded by the first temperature measuring unit within or outside the device. Based on an analysis of the determined heating behavior of the first transducer by the evaluation unit, an imminent overload on the load can consequently be detected.

An advantage attained with at least one embodiment of the invention lies therein that by way of a device of an embodiment or by way of a method of an embodiment, both AC and DC currents can be recorded. Therefore, an imminent overload can be detected for AC and DC loads. Furthermore, a better setting range can be achieved as compared with a bimetallic measuring method. Furthermore, a thermal memory can be realized since, if an overload is imminent, the first transducer is strongly heated such that, based on the temperature and thus the cooling of the first transducer, a cooling behavior of the load can be deduced.

In an advantageous embodiment of the invention, the evaluation unit can detect an imminent overload on the load based on a comparison of the determined heating behavior of the first transducer with a reference value stored in the evaluation unit.

The first temperature measuring unit is configured to transmit temperatures to the evaluation unit so that the evaluation unit can determine a heating behavior of the first transducer. Since a reference value is stored in the evaluation unit, by comparing the determined heating behavior with the reference value, a conclusion (evaluation) regarding the present operating state of the load can be drawn. If an overload is in existence, then as compared with nominal operation, a raised current flow and therefore a raised temperature exists. The raised temperature leads to a characteristic heating behavior of the first transducer which can be recognized through a comparison with the stored reference value.

The reference value characterizes, in particular, the heating behavior of the first transducer over time, depending on the current flow through the first transducer, so that an overload on the load can be identified. Through a comparison of the determined heating behavior of the first transducer with the reference value, a distinction can therefore be made between heating behavior caused by nominal operation and heating behavior of the first transducer caused by an imminent overload.

In another advantageous embodiment of the invention, on detection of an imminent overload on the load, the evaluation unit can output a warning signal, in particular an electrical warning signal. By way of the warning signal, in particular, a switch setting of a switching element of the device can be controlled. By way of the switching element, either an auxiliary circuit or a main current circuit (supply conductor of the energy supply of the electrical load) is controlled directly.

If the switching element controls the auxiliary circuit, the switching element is opened or closed so that a switching device (e.g. protection) switching the main circuit is actuated. This switching device switching the main circuit then opens the main circuit so that the current flow to the load is interrupted and therefore the overload on the load is prevented.

If the switching element controls the main circuit, the switching element is opened so that the current flow to the load is interrupted and therefore the overload on the load is prevented.

If a multi-phase load is present, preferably by determining an imminent overload on only one current path of the device (and thus on only one phase of the load), all the phases of the load are opened by the device so that the current flow to the load is cut off.

In a further advantageous embodiment of the invention, the first temperature measuring unit comprises a first and second temperature sensor, wherein the first temperature sensor can record the temperature of the first transducer and the second temperature sensor can record a reference temperature.

The evaluation unit is preferably configured to be able to determine and finally evaluate the heating behavior of the first transducer by way of recorded temperatures of the first transducer and reference temperatures.

By way of balancing a recorded temperature of the first transducer with a simultaneously recorded reference temperature in the evaluation unit, external temperature influences can be excluded as substantial error sources as far as possible. By use of the evaluation unit, therefore, a heating behavior of the first transducer caused exclusively by current and characterizing an overload on the load can be detected.

If an overload on the load is imminent, a raised current flow and therefore a raised temperature exists in relation to nominal operation of the load (e.g. an electric motor) at the first transducer. The first temperature sensor thus detects a current-related raised temperature. The second temperature sensor determines, for example, a temperature in the device as the reference temperature so that by a comparison of the temperature of the first temperature sensor with the reference temperature of the second temperature sensor, the current-related heating behavior of the first transducer can be determined. In this way it can be ruled out that the determined heating behavior of the first transducer is not heating of the first transducer by a rise in the ambient temperature at the device, but rather is current-related heating at the first transducer. When the heating behavior of the first transducer is analyzed, in particular, an analysis of the temperature of the first transducer over time, that is, the heating of the first transducer over time is analyzed.

By comparing the temperatures of the first and second temperature sensors, it can thus be detected whether, due to the existing motor current flowing through the transducer, current-related heating of the first transducer, which characterizes an imminent overload on the load, has taken place or not.

The reference temperature is preferably obtained through a measurement of a temperature by the second temperature sensor in the device.

Recording of the temperature with the first and second temperature sensors preferably takes place simultaneously.

By use of the first and second temperature sensors, preferably, a temperature difference of ca. 4 Kelvin can be determined by the evaluation unit.

Therefore, a heating behavior over time of the first transducer caused by the current flow through the first transducer and characterizing an overload on the load (current-related heating) can be detected.

The first transducer preferably has a temperature during nominal operation of the load in the range of approximately 60° C. to 100° C. However, given a maximum overload on the load, a temperature in the range of 600° C. to 700° C. can arise at the first transducer.

In a further advantageous embodiment of the invention, the first temperature sensor is spaced a maximum of 2 mm apart from the first transducer.

In a further advantageous embodiment of the invention, the monitoring arrangement is configured such that for determination over time of the heating behavior of the first transducer, the temperature of the first transducer is recorded at least twice.

If the reference temperature is also recorded by the device (the second temperature sensor is present), then to determine the heating behavior of the first transducer, the temperature of the first transducer and the reference temperature are preferably recorded simultaneously at least twice.

In a further advantageous embodiment of the invention, the monitoring arrangement is configured such that for determination of the heating behavior of the first transducer, the temperature of the first transducer is repeatedly recorded at a fixed defined time interval and then evaluated.

If the reference temperature is also recorded by the device (the second temperature sensor is present), then to determine the heating behavior of the first transducer, the temperature of the first transducer and the reference temperature are preferably recorded simultaneously.

In a further advantageous embodiment of the invention, an insulating layer is arranged between the first temperature sensor and the first transducer. By this, a reliable electrical isolation of the first temperature monitoring device from the first transducer is ensured. Furthermore, good thermal coupling of the temperature sensor to the corresponding transducer can be achieved with the insulating layer. The insulating layer is preferably used as a support for the temperature sensor. The insulating layer is, for example, FR4 circuit board material, paint, glass, mica or a ceramic material.

In a further advantageous embodiment of the invention, the device also has a second current path which comprises two lines, wherein the monitoring arrangement also comprises a second temperature measuring unit and a second transducer which creates an electrically conductive connection between the two lines of the second current path, wherein the second temperature measuring unit is electrically isolated from the second transducer and can record the temperature of the second transducer so that the evaluation unit can detect an imminent overload on the load by way of the recorded temperature of the second transducer.

For this purpose, the second temperature measuring unit has a third temperature sensor which can determine the temperature at the second transducer so that the evaluation unit can determine a current-related heating behavior of the second transducer. Determination of the heating behavior of the second transducer by the evaluation unit is carried out by analysis of the recorded temperature of the second transducer over time. Preferably and additionally, in particular simultaneously, a reference temperature is determined (e.g. the reference temperature recorded by the second temperature sensor of the first temperature measuring unit) and is also analyzed so that “not current-related” heating (e.g. due to the ambient temperature) remains unconsidered. By way of the evaluation of the determined heating behavior, an imminent overload on the load can be detected.

In a further advantageous embodiment of the invention, the device also has a third current path which comprises two lines, wherein the monitoring arrangement also comprises a third temperature measuring unit and a third transducer which creates an electrically conductive connection between the two lines of the third current path, wherein the third temperature measuring unit is electrically isolated from the third transducer and can record the temperature of the third transducer so that the evaluation unit can detect an imminent overload on the load by way of the recorded temperature of the third transducer.

For this purpose, the third temperature measuring unit has a fourth temperature sensor which can determine the temperature at the third transducer so that the evaluation unit can determine a current-related heating behavior of the third transducer. Determination of the heating behavior of the third transducer by the evaluation unit is carried out by analysis of the temperature of the third transducer over time. Preferably and additionally, in particular simultaneously, a reference temperature is determined (e.g. the reference temperature recorded by the second temperature sensor of the first temperature measuring unit) and is also analyzed so that “not current-related” heating of the third transducer (e.g. due to the ambient temperature) remains unconsidered. By way of the evaluation of the determined heating behavior, an imminent overload on the load can be detected.

The second and/or third temperature measuring unit can be configured according to the first temperature measuring unit, i.e.:
two temperature sensors can be present per temperature measuring unit,
the temperature sensors can be spaced a maximum of 2 mm apart from the corresponding measuring unit and/or
an insulating layer can be arranged between the temperature sensors and the corresponding transducers,
etc.

It is also conceivable that the first and/or second and/or third temperature measuring unit comprises further temperature sensors so that precise determination of the heating behavior at the associated transducer can be carried out. Preferably, the temperature of the respective transducer is directly measured directly with two temperature sensors in each case, so that the heating behavior of the transducer can be determined by the evaluation unit.

In a further advantageous embodiment of the invention, each temperature sensor is configured such that said sensor assumes a characteristic state depending on the prevailing temperature. The temperature sensor is, in particular, a thermoelement (e.g. a thermoelectric wire), a temperature-dependent semiconductor (e.g. diode, PTC thermistor) or a resistance thermometer (e.g. PT100, PT1000). If, for example, a diode is used as the temperature sensor, then based on a measurement of the voltage at the diode, a conclusion can be drawn concerning the prevailing temperature. A change in the temperature of the first transducer would therefore lead to a temperature change at the diode, which results in a voltage change.

In a further advantageous embodiment of the invention, the first transducer and, where present, the second and/or third transducers are each an electrical resistor with temperature-independent properties.

Preferably, the transducer has a constant power loss and a characteristic heating curve. The transducer is preferably a shunt.

Part of the heating curve of each transducer is available to the evaluation unit as a reference value, so that the evaluation unit can recognize an imminent overload by way of a comparison of the determined heating behavior with the reference value. The result is an evaluation of the determined heating behavior. During the comparison with the reference value, in particular the heating behavior of the respective transducer over a defined time interval is observed. Thus, the determined temperatures of each transducer is analyzed over a defined time interval. If the transducers and the associated temperature sensors of the temperature measuring unit are identically configured, the reference value for the transducers can be identically configured.

In a further advantageous embodiment of the invention, the device is a switching device, in particular an overload relay or a circuit breaker (e.g. motor overcurrent protection, system protection switch).

The device is arranged, in particular, remote from the load and thus is not a part of the load (e.g. electric motor).

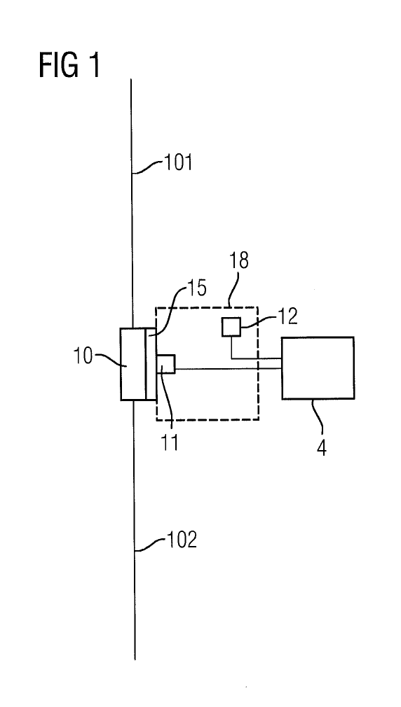

FIG. 1 shows a schematic view of a first current path which comprises a monitoring arrangement. The current path shown is part of a device for protecting a downstream load. By way of the monitoring arrangement, an imminent overload on the load can be detected. For this purpose, the device is integrated into the conducting route of the load. If, for example, the load is a three-phase motor, then at least one supply conductor (phase) of the three-phase motor has the current path and monitoring arrangement illustrated.

The first current path comprises a first line 101 and a second line 102. The monitoring arrangement comprises a first temperature measuring unit 18, an evaluation unit 4 and a first transducer 10. The first temperature measuring unit 18 comprises a first temperature sensor 11 and a second temperature sensor 12, wherein the temperature of the first transducer 10 can be recorded with the first temperature sensor 11 and a reference temperature can be recorded with the second temperature sensor 12. The second temperature sensor 12 is positioned such that, in relation to the first temperature sensor 11, a different measuring point (other temperature measurement site) is recorded so that current-related heating of the first transducer 10 can be determined. The first and second temperature sensors 11, 12 each consist of a semiconductor, in particular a diode, so that by measuring the voltage thereof, a conclusion can be drawn about the prevailing temperature.

The determined temperatures of the first and second temperature sensors 11, 12 are made available to the evaluation unit 4, so that the evaluation unit can determine a current-related heating of the first transducer 10. The determination of the current-related heating of the first transducer 10 and thus the current-related heating behavior of the first transducer 10 is carried out by analyzing the recorded temperatures of the first and second temperature sensors 11, 12 over time. By use of the temperature sensors 11, 12 and the evaluation unit 4, in particular, heating of the first transducer 10 by ca. 10 Kelvin can be determined, particularly in the range from −10° C. to 200° C.

The first transducer 10 is arranged between the first line 101 and the second line 102 of the first current path so that a current can flow from the first line 101 via the first transducer 10 to the second line 102. Since the supply of energy to the downstream load takes place via the first line 101 and the second line 102, during operation of the downstream load, the current flows via the first transducer 10. Depending on the prevailing operational state of the downstream load, a current level exists at the first transducer 10. Depending on this current level and the conducting interval at the first transducer 10, a defined degree of heating of the first transducer 10 takes place. Consequently, a characteristic heating behavior takes place at the first transducer 10. If a thermal overload on the load is imminent, then a raised current level exists at the first transducer 10. Therefore by evaluating the determined heating behavior of the first transducer 10 over a defined time interval by the evaluation unit 4, conclusions can be drawn regarding the prevailing state of the downstream load. During nominal operation, typically a temperature in the range of 60° C. to 100° C. exists at the first transducer 10. However, if an overload occurs on the load, then due to the increased current flow, a temperature of up to 700° C. can arise at the first transducer 10.

Thus, by monitoring the temperature of the first transducer 10, an imminent overload on the load can be detected. For this purpose, the temperature measuring unit 18 comprises the two temperature sensors 11, 12. The first temperature sensor 11 is spaced a maximum of 2 mm from the first transducer 10 and can record the temperature thereof. An insulating layer 15 is arranged between the first temperature sensor 11 and the first transducer 10 so that an electrical isolation of the two components is ensured.

The first temperature sensor 11 records the temperature of the first transducer 10, the second temperature sensor 12 simultaneously records a reference temperature within the device, so that, based on recorded temperatures (temperatures of the first transducer 10 and reference temperatures), the evaluation unit 4 can determine a current-related heating behavior of the first transducer 10. The first and second temperature sensors 11, 12 are spatially separated in this example embodiment (by more than 0.05 mm) from the first transducer. Furthermore, the second temperature sensor 12 is spaced at least 4 mm from the first temperature sensor 11, so that a current-related heating behavior of the first transducer 10 can be calculated by the evaluation unit 4. However, it is also conceivable for the second temperature sensor 12 to record the temperature of the first transducer 10 in relation to the first temperature sensor 11 at another measuring point of the first transducer 10 so that a heating behavior of the first transducer 10 can be determined.

The first transducer 10 is a metallic electrical resistor (shunt) which has a characteristic heating curve. The characteristic heating behavior of the first transducer 10 is available to the evaluation unit 4 as a reference value so that, based on a comparison of the determined prevailing heating behavior of the first transducer 10, particularly during a defined time interval, with the reference value, a conclusion can be drawn concerning the prevailing loading condition of the load. The evaluation unit 4 can therefore continuously monitor a value of the first transducer 10 characterizing the current size and the conducting interval, so that based on the prevailing heating behavior of the first transducer 10 and thus based on the thermal state thereof, a motor or conductor protection can be derived. It can therefore be determined whether an overload exists on the downstream load or not.

In FIG. 1, only one phase is monitored by the monitoring arrangement. However, it is equally conceivable that for multi-phase loads, each phase or at least two phases, each comprise(s) a temperature measuring unit.

The temperature sensors 11, 12 can measure the temperature with a high resolution, for example, less than 1 Kelvin. In this way, it is possible to use small temperature differences and with small electrical resistance values of the first transducer 10. By this, the measurement range with regard to the current lower limit can be significantly increased downwardly, so that the setting range can be significantly increased as compared, for example, with the bimetallic release. A typical value for the temperature necessary with bimetallic releases is, for example, 50 Kelvin overtemperature.

However, for release by way of a first transducer 10, heating by less than 10 Kelvin is sufficient. A setting range of greater than 1 to 4 can thus be realized.

The evaluation of the current-related heating behavior of the first transducer 10 over the temperature thereof is largely independent of frequency and is therefore suitable for AC and DC uses.

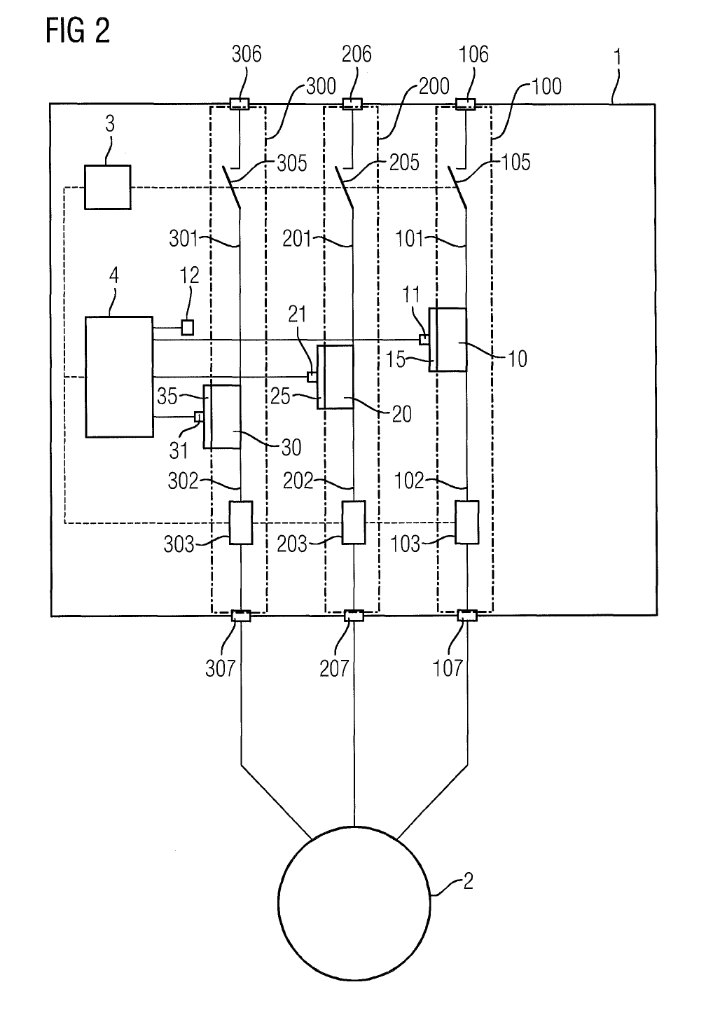

FIG. 2 shows a schematic representation of a device 1 for protecting an electrical load 2. In this example embodiment, the device 1 is a circuit breaker 1, with which a load 2, specifically a three-phase electric motor, can be monitored. For this purpose, the circuit breaker 1 is inserted into the supply line of the load 2 so that, with the circuit breaker 1, the three phases of the load 2 can be monitored.

So that the circuit breaker 1 can be integrated into the supply line of the electrical load 2, the circuit breaker has input-side connection devices 106, 206, 306 and output-side connection devices 107, 207, 307. Therefore, the individual phases of the load 2 are arranged electrically isolated in the circuit breaker 1. The first phase is formed via the first current path 100, the second phase is formed via the second current path 200, and the third phase of the load 2 is formed via the third current path 300. For the first phase, the energy flow to the load 2 can be interrupted by a switching element 105 of the first current path 100. For the second phase, the energy flow to the load 2 can be interrupted by a switching element 205 of the second current path 200. For the third phase, the energy flow to the load 2 can be interrupted by a switching element 305 of the third current path 300. Control of the switching elements 105, 205, 305 is achieved by way of a breaker mechanism 3.

The breaker mechanism 3 is connected to the evaluation unit 4 and to the short-circuit release 103 of the first current path 100, the short-circuit release 203 of the second current path 200 and the short-circuit release 303 of the third current path 300.

With the short-circuit releases 103, 203, 303 of the individual current paths 100, 200, 300 and thus in the individual phases of the load 2, a short-circuit occurring in the individual current paths and thus in the individual phases of the load 2 can be detected so that, on detection of a short-circuit, the energy supply to the load 2 can be cut off. For this purpose, a suitable signal is passed by the short-circuit releases 103, 203, 303 to the breaker mechanism 3, so that the breaker mechanism can open the switching elements 105, 205, 305.

Furthermore, the circuit breaker comprises a monitoring device with which the imminent overload of the electrical load 2 can be detected. For this purpose, the first current path 100 comprises, as FIG. 1 shows, a first line 101 and a second line 102. Arranged between the first line 101 and the second line 102 is a first transducer 10 which creates an electrical connection between the two lines 101 and 102. The first transducer 10 is, in particular, a metallic electrical resistor with temperature-independent properties. Depending on the existing current level and the conducting interval in the first current path 100, a defined degree of heating of the first transducer 10 takes place.

The temperature of the first transducer 10 can be recorded by use of the first temperature sensor 11 of a first temperature measuring unit. The recorded temperature at the first temperature sensor 11 of the first temperature measuring unit is made available to the evaluation unit 4. An insulating layer 15 between the first transducer 10 and the first temperature sensor 11 of the first temperature measuring unit creates an electrical isolation between the first temperature sensor 11 and the first transducer 10. The first temperature measuring unit also comprises a second temperature sensor 12 which measures a reference temperature within the circuit breaker 1. The temperature recorded is also made available to the evaluation unit 4. The first temperature sensor 11 records the temperature at a different measuring point than does the second temperature sensor 12, so that during active operation of the load 2, current-related heating of the first transducer can be determined by simultaneous recording of the temperatures of the first and second temperature sensors 11, 12. By comparing the temperatures of the first temperature sensor 11 and the second temperature sensor 12 of the first temperature measuring unit, the evaluation unit can determine and subsequently evaluate a characteristic heating behavior at the first transducer 10.

The energy supply to the second phase of the load 2 is fed via the second current path 200. The second current path 200 also comprises a first line 201 and a second line 202. Arranged between the first and second lines 201 and 202 is a second transducer 20 which ensures an electrical connection between the first line 201 and the second line 202. Like the first transducer 10 of the first current path 100, the second transducer 20 is also a defined resistor which assumes a characteristic thermal state depending on the existing current flow and the existing conducting interval. The temperature of the second transducer 20 can be determined by way of a third temperature sensor 21 of a second temperature measuring unit. The third temperature sensor 21 is electrically isolated from the second transducer 20 by an insulating layer 25. By comparing the recorded temperatures of the second temperature sensor 12 with the recorded temperatures of the third temperature sensor 21, the evaluation unit 4 can determine the existing heating at the second transducer 20. In this way, the heating behavior at the second transducer 20 can be analyzed.

The energy supply to the third phase of the load 2 is fed via the third current path 300 so that the third phase can also be monitored for overload. The third current path 300 also comprises a first line 301 and a second line 302. Arranged between the first and second lines 301, 302 is a third transducer 30 which connects the first and second lines 301, 302 in an electrically conducting manner. A current flowing along the third current path 300 therefore flows via the third transducer 30. Depending on the size of the current and the conducting interval at the third phase, a characteristic current-related heating takes place at the third transducer 30. In order to determine the current-related heating, the temperature of the third transducer 30 is recorded. The temperature of the third transducer 30 can be determined by use of a fourth temperature sensor 31 of a third temperature measuring unit and made available to the evaluation unit 4. An insulating layer 35 is arranged between the fourth temperature sensor 31 and the third transducer 30 so that the fourth temperature sensor 31 is electrically isolated from the third transducer 30.

The individual current paths 100, 200, 300 therefore each have transducers 10, 20, 30 which, depending on the prevailing current size and the conducting interval, perform characteristic current-related heating. Based on monitoring of the temperature of the respective transducers 10, 20, 30 over time, the heating behavior over time of each transducer 10, 20, 30 can be analyzed. Through the additional comparison with the reference temperature of the second temperature sensor 12, the analysis of the determined temperatures of the transducers 10, 20, 30 can be reduced to the current-related heating of the transducers 10, 20, 30.

It is also conceivable that, in place of determining the heating behavior of the respective transducers 10, 20, 30 by way of a comparison of the temperatures thereof with the recorded reference temperature of the second temperature sensor 12, determination of the heating behavior of the respective transducers 10, 20, 30 without the reference temperature is carried out by the second temperature sensor through an analysis of the recorded temperatures of the first, third and/or fourth temperature sensors 11, 21, 31 over time. However, heating of the transducers 10, 20, 30 which is not caused by the current flow through the transducers 10, 20, 30 (e.g. ambient temperature) cannot be ruled out.

By way of the determined current-related heating of the transducers 10, 20, 30, therefore, conclusions can be drawn regarding the existing current flow in the corresponding current path and therefore a conclusion can be drawn regarding the existing operating state of the load 2, since when an overload is imminent, a raised current flow exists in the individual phases of the load.

The heating characteristic of the first, second and third transducers 10, 20, 30 is known to the evaluation unit 4 and is stored as a reference value. The evaluation unit 4 can therefore detect an imminent overload of the electrical load 2 by comparing the current-related heating behavior of the individual transducers 10, 20, 30, particularly over a defined time interval, with the reference value and instigate suitable countermeasures. The time interval over which the analysis of the heating behavior of the respective transducer 10, 20, 30 is carried out is preferably selected depending on the actual temperature of the respective transducer 10, 20, 30. When an imminent overload on the load 2 is detected, the evaluation unit 4 outputs a warning signal to the breaker mechanism 3 so that the switching elements 105, 205, 305 are opened and thus the energy flow to the load is cut off. In this way, thermal damage to the load 2 by an overload can be prevented.

In that a thermal overload on the load 2 is detected by an evaluation of the heating behavior of the transducer 10, 20, 30, the transducer 10, 20, 30 also provides a thermal memory so that the load cannot be accidentally switched on shortly after a thermal overload. Only after the transducer 10, 20, 30 has undergone a defined cooling, can the load 2 be connected to the supply network again, so that the load is supplied with current once again. The determination of the necessary cooling of the load is also carried out by the evaluation unit 4 by analyzing the temperatures of the transducer 10, 20, 30. For this purpose, reference values are also available to the evaluation unit 4.

The device 1 for monitoring a thermal overload of a load 2 is illustrated in FIG. 2 using the example of a circuit breaker 1. The device 1 can also be, for example, an overload relay. In this case, the short-circuit releases 103, 203 and 303 and possibly the breaker mechanism 3 and the switching elements 105, 205, 305 to be controlled thereof would not be present.

The temperature sensors 11, 12, 21, 31 are semiconductors, in particular diodes, so that through analysis of the voltage thereof, the temperature at the temperature sensors can be determined. In order to increase the measuring accuracy, a plurality of temperature sensors can also be placed on the transducers 10, 20, 30. It is also conceivable that the second temperature sensor 12 is placed outside the device 1.

A line for which protection against thermal overload must be ensured can also be regarded as the load 2.

A great advantage of the device 1 and, in particular, of the monitoring arrangement lies therein that the electrical isolation between the individual phases (current paths 100, 200, 300) and between the individual temperature sensors 11, 21, 31 and the current paths 100, 200, 300 is easy to create.

1. A device for protecting a load with a first current path having two lines, comprising
a monitoring arrangement for detecting an imminent overload on the electrical load, the monitoring arrangement including:
a first transducer configured to establish an electrically conductive connection between the two lines of the first current path;
a first temperature measuring unit, electrically isolated from the first transducer,
configured to record a temperature of the first transducer; and
an evaluation unit, configured to determine, using recorded temperatures of the first transducer, a heating behavior of the first transducer over time and configured to detect, by evaluating the determined heating behavior of the first transducer over time, an imminent overload on the load.

2. The device of claim 1, wherein the evaluation unit is configured to detect an imminent overload on the load based on a comparison of the determined heating behavior of the first transducer with a reference value stored in the evaluation unit.

3. The device of claim 1, wherein, upon detection of an imminent overload on the load, the evaluation unit is configured to output a warning signal.

4. The device of claim 1, wherein the first temperature measuring unit comprises a first and second temperature sensor, wherein the first temperature sensor is configured to record the temperature of the first transducer and the second temperature sensor is configured to record a reference temperature, and wherein the evaluation unit is configured to determine and evaluate the heating behavior of the first transducer by way of recorded temperatures of the first transducer and reference temperatures.

5. The device of claim 4, wherein the first temperature sensor is spaced a maximum of 2 mm apart from the first transducer.

6. The device of claim 4, wherein an insulating layer is arranged between the first temperature sensor and the first transducer.

7. The device of claim 1, wherein the monitoring arrangement is configured such that for determination of the heating behavior of the first transducer over time, the temperature of the first transducer is recorded at least twice.

8. The device of claim 1, wherein the monitoring arrangement is configured such that for determination of the heating behavior of the first transducer over time, the temperature of the first transducer is repeatedly recorded at a fixed defined time interval.

9. The device of claim 1, further including a second current path which comprises two lines, wherein the monitoring arrangement also comprises a second temperature measuring unit and a second transducer which creates an electrically conductive connection between the two lines of the second current path, wherein the second temperature measuring unit is electrically isolated from the second transducer and is configured to record the temperature of the second transducer, and wherein the evaluation unit is configured to detect an imminent overload on the load by way of the recorded temperature of the second transducer.

10. The device of claim 9, further including a third current path which comprises two lines, wherein the monitoring arrangement also comprises a third temperature measuring unit and a third transducer which creates an electrically conductive connection between the two lines of the third current path, wherein the third temperature measuring unit is electrically isolated from the third transducer and is configured to record the temperature of the third transducer, and wherein the evaluation unit is configured to detect an imminent overload on the load by way of the recorded temperature of the third transducer.

11. The device of claim 1, wherein the first transducer is a resistor with a defined heating curve.

12. The device of claim 1, wherein the device is a switching device.

13. The device of claim 1, wherein the first current path comprises a switching element by way of which the energy flow to the load is interruptible.

14. The device of claim 1, wherein the first current path comprises an input-side connection device and an output-side connection device.

15. A method for protecting a load, wherein a device includes a first current path including two lines and a monitoring arrangement for detecting an imminent overload on the load, wherein the monitoring arrangement includes a first temperature measuring unit, an evaluation unit and a first transducer configured to establish an electrically conductive connection between the two lines of the first current path, wherein the first temperature measuring unit is electrically isolated from the first transducer, the method comprising:
recording, via the first temperature measuring unit, a temperature of the first transducer at least twice;
determining, via the evaluation unit, and using the recorded temperatures of the first transducer, a heating behavior of the first transducer over time; and
evaluating, via the evaluation unit, the determined heating behavior of the first transducer over time, and detecting an imminent overload on the load.

16. The device of claim 3, wherein the warning signal is an electrical warning signal.

17. The device of claim 9, wherein the first transducer and the second transducer are each respectively resistors with a defined heating curve.

18. The device of claim 10, wherein the first transducer, the second and the third transducers are each respectively resistors with a defined heating curve.

19. The device of claim 12, wherein the switching device is an overload relay or a circuit breaker.

20. A monitoring arrangement for an overload protection device, comprising:
a first transducer configured to establish an electrically conductive connection between two lines of a current path;
a first temperature measuring unit, electrically isolated from the first transducer, configured to record a temperature of the first transducer; and
an evaluation unit, configured to determine, using recorded temperatures of the first transducer, a heating behavior of the first transducer over time and configured to detect, by evaluating the determined heating behavior of the first transducer over time, an imminent overload on a load of the first current path.
